(19) United States
(12) Patent Application Publication
(10) Pub. No.: US 2004/0146173 A1
(43) Pub. Date: Jul. 29, 2004

(54) Racetrack-shaped magnetic loop and coil for use in the miniature electro-dynamic transducer

(76) Inventors: Zhengmin Pan, La Verne (US); Xingzhi Huang, Shenzhen (CN); Panda Sheng, Shenzhen (CN); Shuixuan Cao, Shenzen (CN)

Correspondence Address: Philip K. Yu, Esq., Registered Patent Attorney, Ste. 100, 20955 Pathfinder Road, Diamond Bar, CA, 91765, US

(21) Appl. No.: 10/753,572

(22) Filed: Jan. 8, 2004

(30) Foreign Application Priority Data
Jan. 13, 2003 (CN) ZL 03222994.1

(51) Int. Cl. H04R 1/00; H04R 9/06; H04R 11/02

(52) U.S. Cl. 381/396; 381/406

(57) ABSTRACT

A miniature electro-dynamic transducer with a racetrack-shaped magnetic loop and coil. The transducer is characterized in that it comprises a membrane, a magnetic loop, a coil. In particular, the geometric shapes of the magnetic loop and the coil are similarly corresponding to the shape of the said membrane.

### FIELD OF THE INVENTION

The present invention relates generally to a kind of magnetic loop and coil, which are racetrack-shaped, also known as “rounded rectangle-shaped,” and used as the driving system in a miniature electro-dynamic transducer, such as the receiver and the micro-speaker etc. Particularly, the caliber of the electro-dynamic transducer is not larger than 60 mm.

### BACKGROUND OF THE INVENTION

All kinds of miniature electro-dynamic transducers are largely used in mobile phones, laptops, game player units etc, which have diverse appearances and performances for various purposes for meeting the needs of their customers. Many products take the shape of the circle, the ellipse, even the quadrate and the racetrack. For the non-circular electro-dynamic transducers, most of their membranes have the shapes like the products, but their coils and magnetic loops remain circle. While the products that have the above configurations are easily assembled and can be used in most of the situations, their capabilities can not match up to the circular ones, and more than this, and their capabilities are difficult to be improved. This is mainly because in the existing product, as the membrane is driven by circular coil, the segment vibrations of the non-circular membrane are larger than the segment vibrations of the circular one. Consequently this will result in increasing the distortions of the wave crest and the trough of the product's frequency response curve. At the same time, the uneven vibration of the membrane will reduce the SPL(sound pressure level) of the device and restrict its power. Furthermore, the membrane is a unitary piece that is usually made by hot-pressing the mylar film, and its equivalent compliance coefficient of resilience is dominated by the short-axis side. For the miniature electro-dynamic transducer, its circular coil can't be shaped too small. Otherwise its long-axis side would not be efficiently vibrated, and then the resonance frequency is difficult to lower and its working frequency band is narrowed.

The object of the present invention is to solve the above problems, which arise in non-circular miniature electro-dynamic transducers (such as the ellipse-, the rectangle- and the racetrack-shaped) when using a circular coil to drive a non-circular membrane. In the embodiment of the present invention, a racetrack-shaped magnetic loop and a coil with a similar shape form a driving system to vibrate the racetrack-shaped membrane, the distribution of the compliance resilient forces between the segments of the membrane is the same as the membrane' in the circular transducer, in which the magnetic loop, the coil and the membrane are all round. When the configuration of the invention is adopted, the frequency distortion may be reduced, the SPL of the device may be increased and the frequency band may be widened.

### SUMMARY OF THE INVENTION

A preferred embodiment of the present invention will be described with reference to FIG. 4 to FIG. 6. The embodiment is characterized in that it includes a membrane, a magnetic loop, a coil, etc. in particular, the geometric shapes of the said magnetic loop and the said coil being similar corresponding to the shape of the said membrane.

In accordance with the present invention, the shapes of the magnetic loop, the coil and the membrane in the present invention are all racetrack-shaped. The said magnetic loop is comprised of an upper splint, a magnet and a T-shaped iron. They compose an outer magnetic structure, wherein a racetrack-shaped magnetic gap is formed, and a racetrack-shaped coil is inserted in it. The said magnetic loop may also be formed in an inner magnetic structure, in which a racetrack-shaped magnetic loop is adopted too, and correspondingly a racetrack-shaped coil is laid in it.

Contrasting with the conventional technology, the present invention has advantages in its performances such as lower frequency distortion, higher power and wider frequency response band.

The detailed features of the present invention will be shown hereinafter.

### BRIEF DESCRIPTION OF THE DRAWINGS

FIGS. 1(a) and (b) is a sketch drawing showing the outer magnetic loop of the conventional circular miniature transducer.

FIGS. 2(a) and (b) is a sketch drawing showing the inner magnetic loop of the conventional circular miniature transducer.

FIGS. 3(a)-(c) is a sketch drawing of a typical miniature transducer wherein a circular magnetic loop is used to vibrate a racetrack-shaped membrane.

FIGS. 4(a)-(c) is a sketch drawing of the racetrack-shaped outer magnetic loop in the present invention.

FIGS. 5(a)-(c) is a sketch drawing of the racetrack-shaped inner magnetic loop in the present invention.

FIGS. 6(a)-(c) is a sketch drawing of a miniature transducer adopting the present invention wherein a racetrack-shaped magnetic loop is set to vibrate a racetrack-shaped membrane.

### DESCRIPTION OF PREFERRED EMBODIMENT

The present invention will be further described in the following in conjunction with the accompanying drawings.

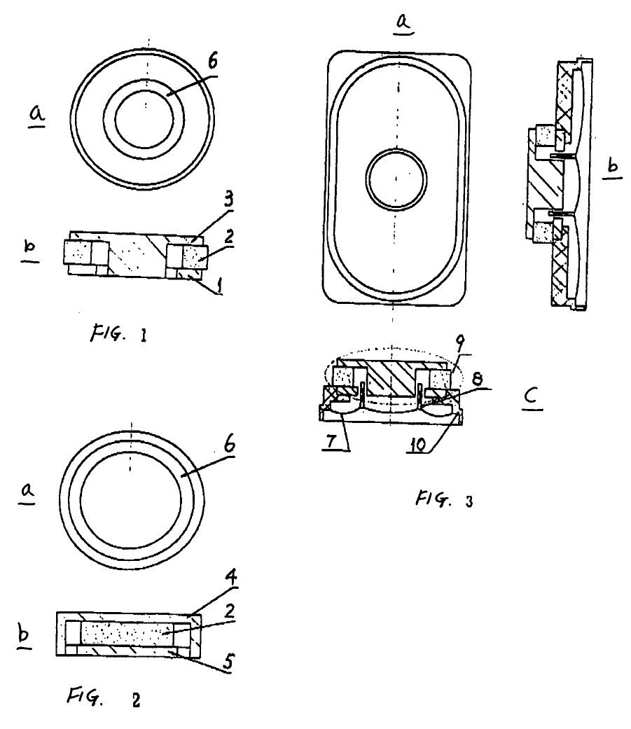

In FIG. 1 and FIG. 2, two traditional magnetic loops are shown, respectively the outer magnetic and the inner magnetic structure. They are usually adopted in the miniature electro-dynamic transducers. The outer magnetic loop is comprised of an upper splint (1), a magnet (2) and a T-shaped iron (3), and the inner-magnetic loop is comprised of a magnetic transfer (4), a magnet (2) and a pole piece (5), forming a circular magnetic loop (6). As shown in FIG. 3, various miniature transducers with new configurations can be developed, and one of them is racetrack-shaped. But then, although the membrane (7) of the product is racetrack-shaped, the driving coil (8) remains circular, and so is the magnetic loop (9), any more, the frame (10) on which the membrane (7) is mounted may take the shape of racetrack or rectangle. The electro-acoustic product adopting the above structure is easily assembled and can be used in most of the situations, but its capability can't come up to the circular one, and more than this, the capability is difficult to be improved. This is mainly because that, as the non-circular membrane (7) is driven by circular coil (8), the segment vibrations of the membrane (7) are larger than the segment vibrations of the circular one, consequently this will result in increasing the distortions of the wave crest and the trough of the product's frequency response curve. At the same time, the uneven vibration of the membrane will reduce the SPL(sound pressure level) of the device and restricts its power., further more, the membrane (7) is a unitary that usually made by hot-pressing the mylar film, its equivalent compliance coefficient of resilience is dominated by the short-axis side. For the miniature electro-dynamic transducer, its circular coil (8) can't be shaped too small. Otherwise its long-axis side should not be efficiently vibrated, and then the resonance frequency is difficult to lower and its working frequency band is narrowed.

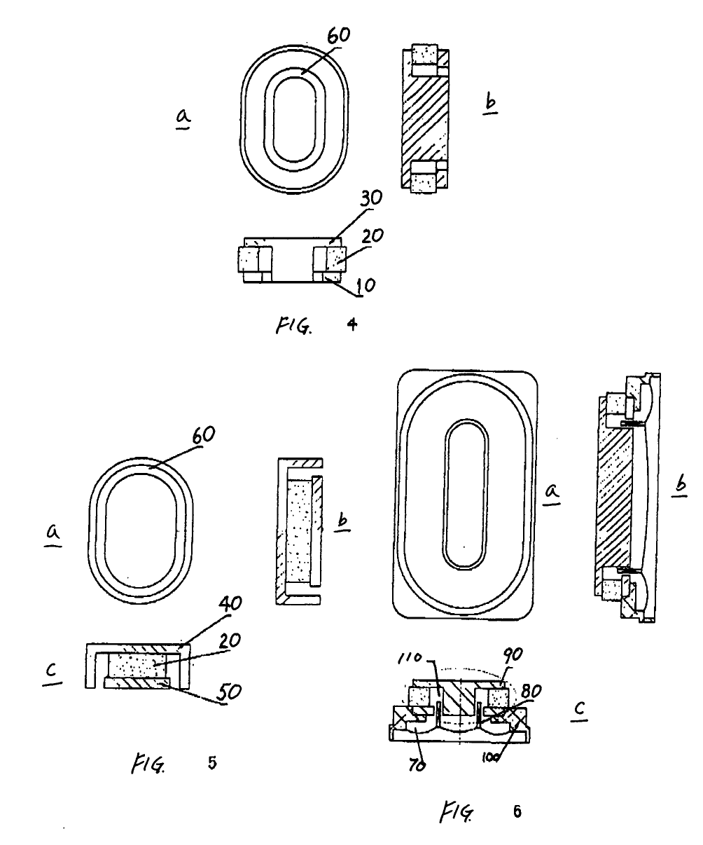

As shown in FIG. 4 and FIG. 5, a new configuration with racetrack-shaped magnetic loop and racetrack-shaped coil is disclosed in the present invention. The magnet and the transfer are overlapped together in the same way as assembling the traditional magnetic driving system, but the formed magnetic loop (60) is different, which is also a racetrack-shaped other than a circular (6 in FIG. 2). Similarly, the magnetic driving system (90) in the present invention can also adopt the outer magnetic loop or the inner magnetic loop. The outer magnetic loop, as shown in FIG. 4, is comprised of an upper splint (10), a magnet (20) and a T-shaped iron (30), and the inner-magnetic loop, as shown in FIG. 5, is comprised of a pole piece (50), a magnet (20) and a magnetic transfer (40).

For the racetrack-shaped outer magnetic loop of FIG. 4, the upper splint (10) is an annular piece whose inside is racetrack-shaped and the outside isn't limited to be this, and the magnet (20) isn't limited to be racetrack-shaped either. As for the T-shaped iron 30, its magnetic transfer post is racetrack-shaped and its chassis may take other shape.

In the racetrack-shaped inner magnetic loop of FIG. 5, the pole piece (50) and the magnetic transfer (40) are settled to be racetrack-shaped, and the magnet (20) is preferred to, but not limited to, be racetrack-shaped.

In the gap of the racetrack-shaped magnetic loop, a permanent magnetic field is formed and a racetrack-shaped coil is set in it. The principle of the electro-dynamic transducer is that: as the electric signal is input to the coil (80), the coil (80) in the magnetic field will oscillate along with the alternating current passing through it, and drive the membrane (70) to vibrate to make a sound.

In FIG. 6, a miniature electro-dynamic transducer adopting the present invention is shown. The characteristic of the present invention is that a racetrack-shaped magnetic loop (110) is set to vibrate a racetrack-shaped membrane (70). Using a racetrack-shaped magnetic loop (100) and a coil (80) with similar shape to form a driving system to vibrate the racetrack-shaped membrane (70), the broken-up vibrations in the whole membrane (70), wherever along the long-axis or along the short-axis, are similar with the situations in the circular membrane. The performance of the device can also match up to that of the traditional product with circular magnetic loop and circular coil, and its configuration and application have obvious advantage over the existing products.

What is claimed is:

1. A miniature electro-dynamic transducer for converting an electric signal into sound, comprising a membrane, a magnetic loop and a coil, which is characterized in that the shapes of its magnetic loop and coil are correspondingly similar with the shape of the membrane.

2. A miniature electro-dynamic transducer as in claim 1 in which the shapes of its magnetic loop, its coil and its membrane are correspondingly racetrack-shaped.

3. A miniature electro-dynamic transducer as in claim 2 whose magnetic loop is comprised of an upper splint, a magnet and a T-shaped iron, and they compose an outer magnetic structure, wherein a racetrack-shaped magnetic gap is formed, and a racetrack-shaped coil is inserted in it.

4. A miniature electro-dynamic transducer as in claim 2 whose magnetic loop is comprised of a magnetic transfer, a magnet and a pole piece, and they form an inner magnetic structure, in which a racetrack-shaped magnetic gap is constructed, and a racetrack-shaped coil is laid in it.
